(19) United States
(12) Patent Application Publication
(10) Pub. No.: US 2026/0097367 A1
(43) Pub. Date: Apr. 9, 2026

(54) FILTER CLEANING METHODS AND APPARATUSES

(71) Applicant: Taiwan Semiconductor Manufacturing Company, Ltd., Hsinchu (TW)

(72) Inventors: Yi-Lung CHUNG, Hsinchu (TW); Heng-Yi TSENG, Hsinchu (TW); Shun Chan TENG, Hsinchu (TW); Chih-Cheng HUNG, Hsinchu (TW); Tsung-Han LEE, Hsinchu (TW); Feng-An YANG, Hsinchu (TW); Young CHEN, Hsinchu (TW); Sheng Chia KUO, Hsinchu (TW); Jung-Huang PENG, Hsinchu (TW)

(73) Assignee: Taiwan Semiconductor Manufacturing Company, Ltd., Hsinchu (TW)

(21) Appl. No.: 18/909,234

(22) Filed: Oct. 8, 2024

(51) Int. Cl. B01D 65/02

(52) U.S. Cl. CPC B01D 65/02; B01D 2321/02; B01D 2321/162; B01D 2321/164; B01D 2321/40; B01D 2321/44

(57) ABSTRACT

A method for cleaning a filter includes flowing a cleaning fluid through a filter housing to clean the filter in the filter housing and obtaining flowing parameters of the cleaning fluid. The method further includes determining a condition of the filter based on the flowing parameters of the cleaning fluid, and associating the flowing parameters to attributes of the filter when the condition of the filter is clean.

### BACKGROUND

The semiconductor integrated circuit (IC) industry has experienced exponential growth. Technological advances in IC materials and design have produced generations of ICs where each generation has smaller and more complex circuits than the previous generation. In the course of IC evolution, functional density (i.e., the number of interconnected devices per chip area) has generally increased while geometry size (i.e., the smallest component (or line) that can be created using a fabrication process) has decreased. This scaling-down process generally provides benefits by increasing production efficiency and lowering associated costs. Such scaling down has also increased the quality requirements of chemical liquids applied during the fabrication process.

Filters are used to improve the quality of the chemical liquids by filtering out unwanted particles from the chemical liquids. However, filters may release metal particles and/or other contaminant particles into the chemical liquids when the chemical liquids go through the filters. These metal particles and/or other contaminant particles increase the defect rate of wafer products when the chemical liquids are applied during the fabrication process. It is, therefore, desirable to clean the filters before the filters are applied to the chemical liquids. In particular, selecting flowing parameters of a cleaning fluid to reduce the metal particles and/or other contaminant particles in the filters is critical. Thus, improved methods and apparatus for reducing the metal particles and/or other contaminant particles from the filters are desirable.

### BRIEF DESCRIPTION OF THE DRAWING

The present disclosure is best understood from the following detailed description when read with the accompanying figures. It is emphasized that, in accordance with the standard practice in the industry, various features are not drawn to scale and are used for illustration purposes only. In fact, the dimensions of the various features may be arbitrarily increased or reduced for clarity of discussion.

FIG. 1 illustrates a schematic view of a filter-cleaning apparatus, according to embodiments of the disclosure.

FIG. 2 illustrates a flow diagram of a method for cleaning filters, according to embodiments of the disclosure.

FIG. 3 illustrates a block diagram of an artificial intelligence (AI) engine, according to embodiments of the disclosure.

FIG. 4A illustrates a schematic view of a filter housing assembly, according to embodiments of the disclosure.

FIG. 4B illustrates a schematic view of a filter housing assembly, according to embodiments of the disclosure.

FIG. 5A illustrates a schematic view of a filter housing, according to various aspects of the present disclosure.

FIG. 5B illustrates a side view of a base of the filter housing, according to various aspects of the present disclosure.

FIG. 5C illustrates a top view of a base of the filter housing, according to various aspects of the present disclosure.

FIGS. 6A, 6B, 6C, and 6D illustrate schematic views of filter housings, according to embodiments of the disclosure.

FIGS. 7A and 7B illustrate a computer system for implementing various methods, according to embodiments of the disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. In addition, the term “being made of” may mean either “comprising” or “consisting of.” In the present disclosure, a phrase “one of A, B and C” means “A, B and/or C” (A, B, C, A and B, A and C, B and C, or A, B and C), and does not mean one element from A, one element from B and one element from C, unless otherwise described.

The quality of the chemical liquids applied during the semiconductor fabrication process relies on the filtration of filters. However, metal particles or other contaminant particles contained in the filters may become mobile and enter the semiconductor fabrication process with the chemical liquids, resulting in defects in the wafer products. Embodiments of this disclosure provide an improved apparatus and methods for cleaning the filters, thereby reducing metal particles or other contaminant particles in the filters and improving the efficiency of the semiconductor fabrication process. In some embodiments, the improved apparatuses and methods include using an artificial intelligence (AI) engine to assist with determining conditions of the filters and selecting flowing parameters of the cleaning fluid to reduce and/or remove the metal particles or other contaminant particles in the filters. Consequently, accuracy and efficiency for determining the conditions of the filters and selecting flowing parameters of the cleaning fluid can be improved.

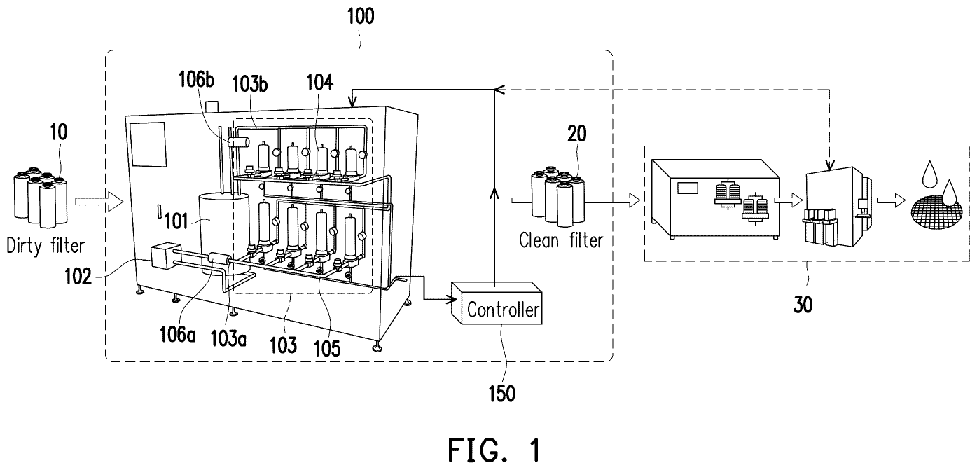

FIG. 1 illustrates a schematic view of a filter-cleaning apparatus in accordance with some embodiments of the present disclosure. In some embodiments, the filter-cleaning apparatus 100 includes a tank 101, a pump 102, and a filter housing assembly 103.

The tank 101 is configured to store a cleaning fluid, and the cleaning fluid may rinse and/or clean filters placed in the filter housing assembly 103 when the cleaning fluid passes through the filters, such that metal particles and/or other contaminant particles in the filters are reduced and/or removed.

In some embodiments, the cleaning fluid is a chemical solution configured to remove the metal particles and/or the other contaminant particles. In some examples, the cleaning fluid includes an acid solution. In some examples, the cleaning fluid includes an alkaline solution.

The pump 102 is connected to and/or coupled with an outlet port (not shown) of the tank 101 and configured to provide a suction pressure to pump the cleaning fluid from the tank to an inlet 103a of the filter housing assembly 103. The cleaning fluid passes through the filter housing assembly 103 and exits through an outlet 103b of the filter housing assembly 103. The outlet 103b of the filter housing assembly 103 is connected to and/or coupled with an inlet port (not shown) of the tank 101, such that the cleaning fluid flows back into the tank 101.

In some embodiments, a pressure difference is maintained between the inlet 103a of the filter housing assembly 103 and the outlet 103b of the filter housing assembly 103. In some examples, the pressure difference is in a range from about 1 psi to about 50 psi. In some examples, the pressure difference is in a range from about 5 psi to about 10 psi.

In some embodiments, the filter housing assembly 103 includes at least one filter housing 104. In some embodiments, the filter housing assembly 103 includes more than one filter housings 104. In some examples, the more than one filter housings 104 are connected in series, such that the cleaning fluid flows through each of the more than one filter housings 104 sequentially. In some examples, the more than one filter housings 104 are connected to and/or coupled in parallel, such that the flow of cleaning fluid is uniformly distributed between the more than one filter housings 104.

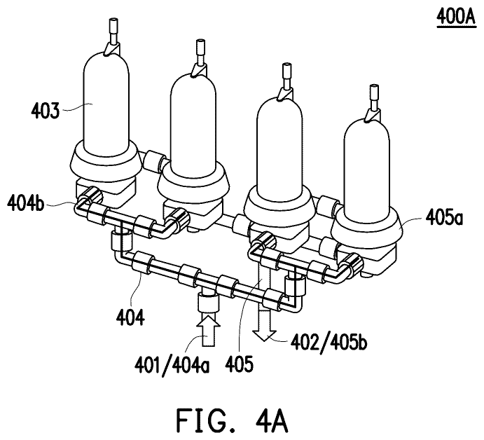

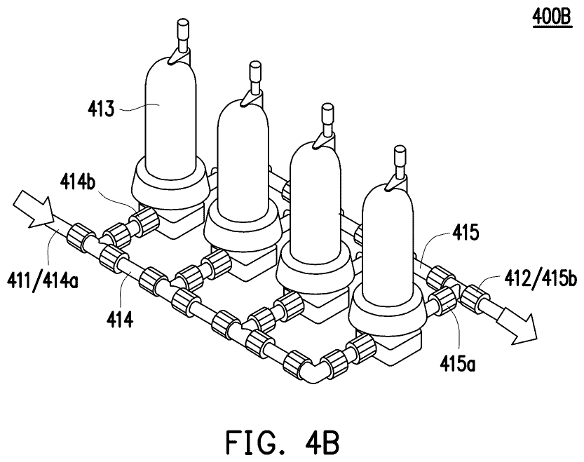

In some embodiments, the filter housing assembly 103 has an arrangement as described below with respect to the filter housing assembly 400A of FIG. 4A or the filter housing assembly 400B of FIG. 4B.

Each of the at least one filter housings 104 is configured to hold one of the filters 10. The filters 10 may include metal particles and/or the other contaminant particles on membranes of the filters 10 before the filter is rinsed and cleaned by the cleaning fluid. The metal particles and/or the other contaminant particles in the filters 10 are reduced and/or removed from the filter 10 when the cleaning fluid flows through the filter.

The clean filters 20 may be applied in a wafer production apparatus 30 to filter and clean the chemical fluid that is applied during the wafter production process.

In some embodiments, the filter-cleaning apparatus 100 further includes connecting tubes 105. The connecting tubes 105 are configured to connect and/or couple to the tank 101, the pump 102, and the filter housing assembly 103 to form a loop for the flow of the cleaning fluid to circulate back to the tank 101. In some examples, the connecting tubes 105 are manifold connecting tubes.

In some embodiments, the filter-cleaning apparatus 100 further includes a first sensor 106a positioned close to the inlet 103a of the filter housing assembly 103 and configured to monitor and/or obtain flowing parameters of the cleaning fluid before the cleaning fluid flows into the filter housing assembly 103. The flowing parameters of the cleaning fluid include at least one of a concentration of metal particles in the cleaning fluid, a flow rate of the cleaning fluid, a pressure of the cleaning fluid, a particle count of the cleaning fluid, and a flush volume of the cleaning fluid.

In some embodiments, the first sensor 106a is a flow rate meter configured to monitor and/or measure a flow rate of the cleaning fluid that flows into the filter housing assembly 103.

In some embodiments, the first sensor 106a is a pressure meter configured to monitor and/or measure a pressure of the cleaning fluid that flows into the filter housing assembly 103.

In some embodiments, the first sensor 106a is a metal particle detector configured to monitor and/or measure a metal content of the cleaning fluid that flows into the filter housing assembly 103.

In some embodiments, the first sensor 106a is a liquid particle counter (LPC) configured to monitor and/or measure a contaminant particle content of the cleaning fluid that flows into the filter housing assembly 103. For example, the liquid particle counter is configured to measure and/or count a number of contaminant particles in the cleaning fluid. In some examples, the contaminant particles that are counted are particles having a diameter greater than 20 nm.

In some embodiments, the first sensor 106a is configured to monitor and/or measure a flush volume of the cleaning fluid that flows through the filter housing assembly 103.

In some embodiments, the filter-cleaning apparatus 100 further includes a second sensor 106b positioned close to the outlet 103b of the filter housing assembly 103 and configured to monitor and/or obtain flowing parameters of the cleaning fluid after the cleaning fluid flows out of the outlet 103b of the filter housing assembly 103. The flowing parameters of the cleaning fluid include at least one of a concentration of metal particles in the cleaning fluid, a flow rate of the cleaning fluid, a pressure of the cleaning fluid, a particle count of the cleaning fluid, and a flush volume of the cleaning fluid.

In some embodiments, the second sensor 106b is a flow rate meter configured to monitor and/or measure a flow rate of the cleaning fluid that flows out of the filter housing assembly 103.

In some embodiments, the second sensor 106b is a pressure meter configured to monitor and/or measure a pressure of the cleaning fluid that flows out of the filter housing assembly 103.

In some embodiments, the second sensor 106b is a metal particle detector configured to monitor and/or measure a metal content of the cleaning fluid that flows out of the filter housing assembly 103.

In some embodiments, the second sensor 106b is a liquid particle counter (LPC) configured to monitor and/or measure a contaminant particle content of the cleaning fluid that flows out of the filter housing assembly 103. For example, the liquid particle counter is configured to measure and/or count a number of contaminant particles in the cleaning fluid. In some examples, the contaminant particles that are counted have a diameter greater than 20 nm.

In some embodiments, the first sensor 106b is configured to monitor and/or measure a flush volume of the cleaning fluid that flows through the filter housing assembly 103.

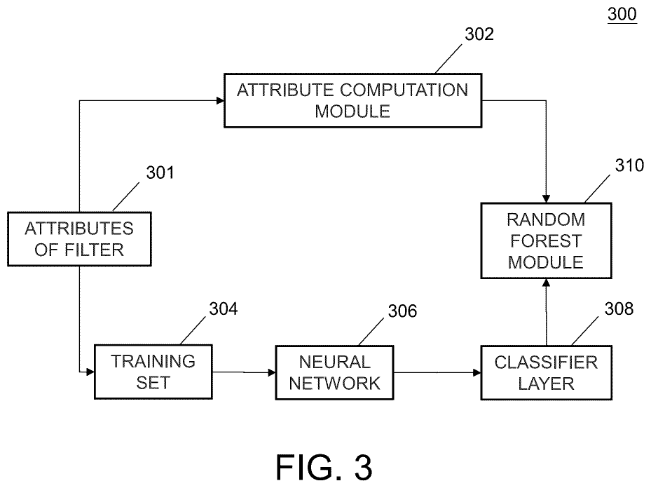

In some embodiments, the filter-cleaning apparatus 100 further includes a controller 150 electrically connected to and/or coupled with the first sensor 106a and the second sensor 106b. The controller 150 is configured to receive and process the generated flowing parameters of the cleaning fluid from the first sensor 106a and the second sensor 106b. In some embodiments, the controller 250 is a microcontroller configured to receive and process the generated flowing parameters of the cleaning fluid and determine a condition of the filters based on the flowing parameters of the cleaning fluid. In some embodiments, the controller 250 is configured to determine a condition of the filters based on the flowing parameters of the cleaning fluid using an artificial intelligence engine 300 described below with respect to FIG. 3.

In some embodiments, the controller 150 is further electrically connected to and/or coupled with the pump 102. The controller 150 is further configured to control and/or adjust the suction pressure of the pump 102 based on the condition of the filters.

In some embodiments, the controller 150 is further electrically connected to and/or coupled with the wafer production apparatus 30. The controller 150 is further configured to receive and/or process the defect rate of the wafer for the clean filters 20. In some embodiments, the controller 150 is further configured to associate the defect rate with the flowing parameters of the cleaning fluid.

It is understood that the controller 150 may be concentrated at a single location or distributed. In one embodiment, the controller 150 is integrated in the filter-cleaning apparatus 100. In another embodiment, the controller 150 is remotely connected to the filter-cleaning apparatus 100 through the internet, intranet or other data communication mechanism. In yet another embodiment, the controller 150 is distributed among a plurality of processing apparatuses and shared by the plurality of processing apparatuses. In yet another embodiment, the controller 150 is a portion of a semiconductor device manufacturing system and is coupled to the filter-cleaning apparatus 100 through a suitable data communication mechanism.

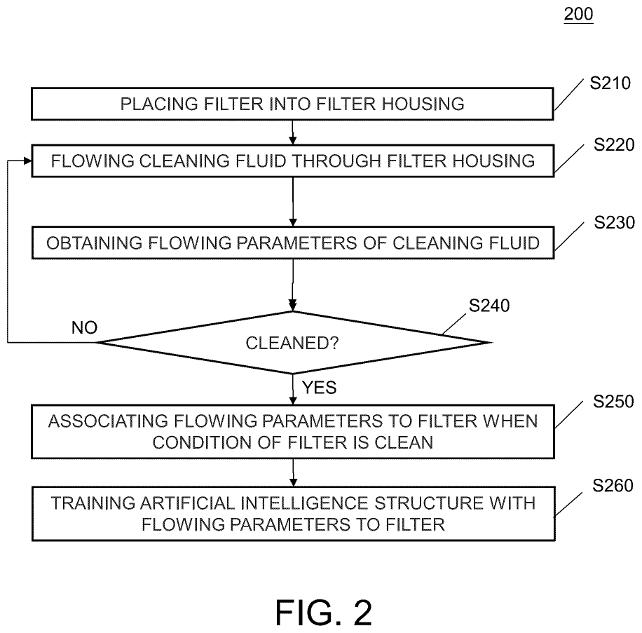

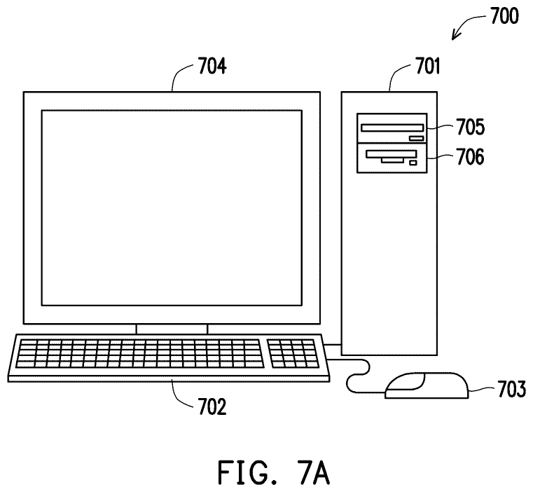

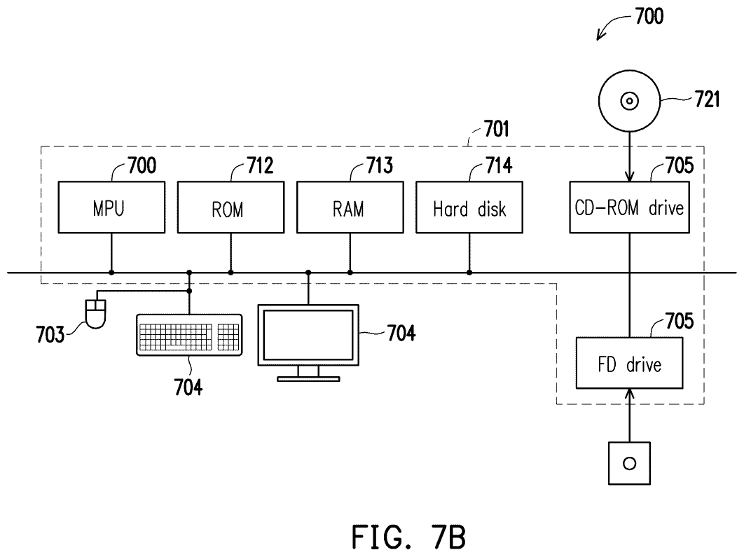

FIG. 2 illustrates a flow diagram of a method 200 for cleaning filters according to embodiments of the disclosure. The method 200 or a portion of the method 200 is performed by a controller (e.g., 150 of FIG. 1). In some embodiments, the method 200 or a portion of the method 200 is performed and/or is controlled by a computer system 700 described below with respect to FIGS. 7A and 7B. The method 200 is an example, and is not intended to limit the present disclosure and what is claimed. Additional operations can be provided before, during, and after the method 200, and some operations described can be replaced, eliminated, or moved around for additional embodiments of the method 200.

In some embodiments, the method 200 includes an operation S210 as shown in FIG. 2. In operation S210, filters 10 are placed into the filter housing assembly 103 as shown in FIG. 1.

In some embodiments, the filter housing assembly 103 includes at least one filter housing 104. In some embodiments, the filter housing assembly 103 includes more than one filter housings 104. In some examples, the more than one filter housings 104 are connected in series, such that the cleaning fluid flows through the more than one filter housings 104 sequentially. In some examples, the more than one filter housings 104 are connected in parallel, such that the flow of cleaning fluid is uniformly distributed between the more than one filter housings 104. In some embodiments, the filter housings 104 are symmetrically positioned with regard to the inlet 103a and the outlet 103b of the filter housing assembly 103, such that the flow of the cleaning fluid is uniformly distributed between the filter housings 104.

In some embodiments, each of the at least one filter housing 104 is configured to hold one of the filters 10. The filters 10 may include metal particles and/or the other contaminant particles on membranes of the filters 10.

In some embodiments, the filters 10 have attributes, such as a material type of the filter, a diameter of the membrane of the filter, a type of the metal particles in the filter, a flow rate of the filter, a pressure drop of the filter, performance requirements, etc. In some embodiments, different flowing parameters of the cleaning fluid may be applied to clean filters 10 with different attributes.

In some embodiments, the method further includes an operation S220 as shown in FIG. 2. In operation S220, a cleaning fluid is configured to flow through the filter housing assembly 103 to clean the filter. In some examples, the flow rate is in a range from 1 liters per minute (LPM) to 100 LPM. In some examples, the flow rate is in a range from 15 LPM to 20 LPM.

In some embodiments, the cleaning fluid enters an inlet 103a of the filter housing assembly 103 and exits through an outlet 103b of the filter housing assembly 103. The outlet 103b of the filter housing assembly 103 is connected to and/or coupled with an inlet port (not shown) of the tank 101, such that the cleaning fluid flows back into the tank 101.

In some embodiments, a pressure difference is maintained between the inlet 103a of the filter housing assembly 103 and the outlet 103b of the filter housing assembly 103. In some examples, the pressure difference is in a range from about 1 psi to about 50 psi. In some examples, the pressure difference is in a range from about 5 psi to about 10 psi.

In some embodiments, when a membrane of the filter has a diameter of 2 nm, the pressure difference is approximately 5 psi, and the flow rate is approximately 15 LPM.

In some embodiments, the tank 101 is configured to store a cleaning fluid, and connected to and/or coupled with the inlet 103a of the filter housing assembly 103. The pump102 is positioned between an outlet port (not shown) of the tank 101 and the inlet 103a of the filter housing assembly 103 and is configured to pump the cleaning fluid from the tank to the inlet 103a of the filter housing assembly 103. In some embodiments, the outlet 103b of the filter housing assembly 103 is connected to and/or coupled with an inlet port (not shown) of the tank 101, such that the cleaning fluid flows back into the tank 101.

In some embodiments, the metal particles and/or the other contaminant particles in the filters 10 are reduced and/or removed from the filter 10 when the cleaning fluid flows through the filters 10. In some embodiments, connecting tubes 105 are configured to connect the tank 101, the pump 102, and the filter housing assembly 103 to form a loop for the flow of the cleaning fluid.

In some embodiments, the method 200 further includes an operation S230 as shown in FIG. 2. In operation S230, flowing parameters of the cleaning fluid are obtained and/or processed by the controller 150.

In some embodiments, the filter-cleaning apparatus 100 further includes at least one sensor (e.g., 106a or 106b) configured to monitor and/or obtain flowing parameters of the cleaning fluid before the cleaning fluid flows into the filter housing assembly 103 and/or after the cleaning fluid flows out of the filter housing assembly 103. The flowing parameters of the cleaning fluid include at least one of a concentration of metal particles in the cleaning fluid, a flow rate of the cleaning fluid, a pressure of the cleaning fluid, a particle count of the cleaning fluid, and a flush volume of the cleaning fluid. In some embodiments, at least one sensor (e.g., 106a or 106b) is configured to monitor the flowing parameters of the cleaning fluid in real-time.

In some examples, the concentration of metal particles in the cleaning fluid is about 5000 parts per trillion (ppt) by volume at the outlet 103b of the filter housing assembly 103 when the cleaning process of the filters 10 starts. The concentration of metal particles in the cleaning fluid is reduced to about 500 ppt by volume at the outlet 103b of the filter housing assembly 103 after 1000 liters of cleaning fluid passes through the filter housing assembly 103. The concentration of metal particles in the cleaning fluid is further reduced to about 1 ppt by volume at the outlet 103b of the filter housing assembly 103 after 2000 liters of cleaning fluid goes through the filter housing assembly 103.

In some embodiments, the method further includes an operation S240 as shown in FIG. 2. In operation S240, the controller 150 is further configured to determine a condition of the filter based on the flowing parameters of the cleaning fluid.

In some embodiments, the controller 150 is electrically connected to and/or coupled with the at least one sensor (e.g., 106a or 106b). The controller 150 is configured to receive and process the generated flowing parameters of the cleaning fluid from the at least one sensor (e.g., 106a or 106b). In some embodiments, the controller 250 is a microcontroller configured to receive and process the generated flowing parameters of the cleaning fluid and determine a condition of the filters based on the flowing parameters of the cleaning fluid.

In some embodiments, the controller 250 is configured to determine initial flowing parameters based on the attributes of the filters. In some embodiments, the controller 250 is configured to determine the flowing parameters of the cleaning fluid using an artificial intelligence engine 300 described below with respect to FIG. 3.

In some embodiments, the controller 150 is further electrically connected to and/or coupled with the pump 102. The controller 150 is further configured to control and/or adjust the suction pressure of the pump 102 based on the condition of the filters.

In some embodiments, the controller 150 is further electrically connected to and/or coupled with the wafer production apparatus 30. The controller 150 is further configured to receive and/or process the defect rate of the wafer for the clean filters 20. In some embodiments, the controller 150 is further configured to associate the defect rate with the flowing parameters of the cleaning fluid.

If the controller 150 determines that the filters are clean, the method further includes an operation S250 as shown in FIG. 2. In operation S250, the controller 150 is configured to associate the flowing parameters to the filter when the condition of the filter is clean. If the controller 150 determines that the filters are not clean, the method further includes repeating operations S220, S230, and S240 as shown in FIG. 2.

In some embodiments, the association between the flowing parameters and the filters is saved in a database.

FIG. 3 illustrates a block diagram of an example artificial intelligence (AI) engine 300 according to various aspects of the present disclosure. In some embodiments, the AI engine 300 is implemented as a part of method 200. As shown in FIG. 3, the AI engine 300 comprises an attribute computation module 302, a training set 304, a neural network 306, a classifier layer 308, and a random forest module 310.

In some embodiments, attributes 301 of a filter are fed into the AI engine 300 and received by the attribute computation module 302 and training set 304 in parallel. In an upper portion of the AI engine 300, the attribute computation module 302 may calculate attributes 301 of the filter such as a material type of the filter, a type of the metal particles in the filter, a flow rate of the filter, a pressure drop of the filter, etc. While in a lower portion of the AI engine, the training set 304 provides suitable filters for comparative analysis with the attributes 301 of the filter. The training set 304 provides examples of flowing parameters of the cleaning fluid which were applied to the filter-cleaning apparatus previously and successfully used to clean and/or rinse the filters, and saved in a database. The example flowing parameters of the cleaning fluid are processed by the neural network 306 (e.g., a ResNet 18 network) to generate attributes. In some embodiments, the neural network 306 includes at least one convolution layer and/or a depth-wise separable convolution layer for computing attributes. In some embodiments, there are a large set of attributes, in which case the classifier layer 308 determines and selects the best attributes for additional analysis. In an embodiment, the classifier layer 308 includes at least one fully connected (FC) layer for attribute selection. The classifier layer 308 is implemented as multiple stages, each of which may reduce the number of attributes. The classifier layer 308 determines and outputs a success probability (embedded with other attributes), which is connected to the random forest module 310 to output a final success probability. Therefore, the random forest module 310 mixes or combines both outputs of the attribute computation module 302 and the classifier layer 308 in generating the final success probability. The final success probability is used to determine the success probability of the flowing parameters (e.g., a probability of one means being cleaned successfully, while a probability of zero means no success). Thus, the final success probability may be used in method 200 to help optimize the filter cleaning process.

The upper portion of the AI engine 300 containing the attribute computation module 302 is sometimes called a machine learning portion, while the lower portion of the AI engine 300 containing the training set 304, the neural network 306, and the classifier layer 308 may be called a deep learning portion. The attributes 301 of the filter may represent simulated attributes of the filter (e.g., when the AI engine 300 is used for filter cleaning process optimization) or an actual filter (e.g., when the AI engine 300 is being trained based on a database which includes flowing parameters having cleaned the filters successfully previously, in which case the output success probability may determine the effectiveness of the AI engine 300). The AI engine determines the flowing parameters based on the attributes of the filters. In addition, the AI engine 300 may also help optimize the filter cleaning process using the final success probability.

FIG. 4A illustrates a schematic view of a filter housing assembly 400A in accordance with some embodiments of the present disclosure. FIG. 4B illustrates a schematic view of a filter housing assembly 400B in accordance with some embodiments of the present disclosure.

As shown in FIG. 4A, the filter housing assembly 400A includes an inlet 401 and an outlet 402, and a plurality of filter housings 403. The cleaning fluid flows into the filter housing assembly 400A through the inlet 401, and flows out of the filter housing assembly 400A through the outlet 402.

The plurality of filter housings 403 are arranged in parallel with each other and connected to and/or coupled to the inlet 401 and the outlet 402 through a first manifold 404 and a second manifold 405, respectively. The flow of the cleaning fluid from the inlet 401 goes through a unique path to each of plurality of filter housings 403. The flow of the cleaning fluid is uniformly distributed between the plurality of filter housings 403.

For example, the first manifold 404 is an E-type manifold, such that the cleaning fluid flows into an inlet port 404a of the first manifold 404 and flows out of a plurality of outlet ports 404b of the first manifold 404. Each of the plurality of outlet ports 404b of the first manifold 404 is connected to and/or coupled to an inlet of a corresponding filter housing 403. The plurality of outlet ports 404b of the first manifold 404 are aligned in parallel and the cleaning fluid flows into the inlet port 404a of the first manifold 404 is uniformly distributed between the plurality of outlet ports 404b of the first manifold 404.

Similarly, the second manifold 405 is an E-type manifold, such that the cleaning fluid further flows into a plurality of inlet ports 405a of the second manifold 405 and flows out of an outlet port 405b of the second manifold 405. Each of the plurality of inlet ports 405a of the second manifold 405 is connected to and/or coupled with an outlet of a corresponding filter housing 403.

In some embodiments, as shown in FIG. 4B, the filter housing assembly 400B includes an inlet 411 and an outlet 412, and a plurality of filter housings 413. The cleaning fluid flows into the filter housing assembly 400B through the inlet 411, and flows out of the filter housing assembly 400B through the outlet 412.

The plurality of filter housings 413 are arranged in parallel with each other and connected to and/or coupled with the inlet 411 and the outlet 412 through a first manifold 414 and a second manifold 415. The flow of the cleaning fluid from the inlet 411 goes through a unique path to each of plurality of filter housings 413.

For example, the first manifold 414 is a Z-type manifold, such that the cleaning fluid flows into an inlet port 414a of the first manifold 414 and flows out of a plurality of outlet ports 414b of the first manifold 414. Each of the plurality of outlet ports 414b of the first manifold 414 is connected to and/or coupled with an inlet of the corresponding filter housing 413. The plurality of outlet ports 414b of the first manifold 414 are staggered and the cleaning fluid flows into the inlet port 414a of the first manifold 414 and is distributed between the plurality of outlet ports 414b of the first manifold 414.

Similarly, the second manifold 415 is a Z-type manifold, such that the cleaning fluid flows into a plurality of inlet ports 415a of the second manifold 415 and flows out of an outlet port 415b of the second manifold 415. Each of the plurality of inlet ports 415a of the second manifold 415 is connected to and/or coupled with an outlet of the corresponding filter housing 413.

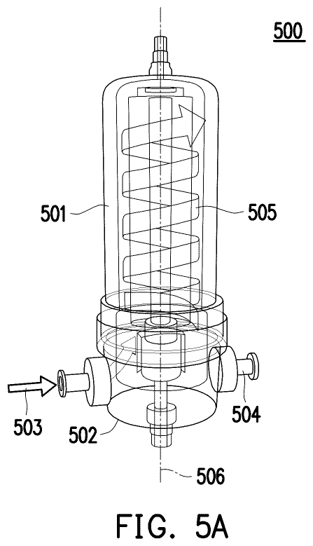

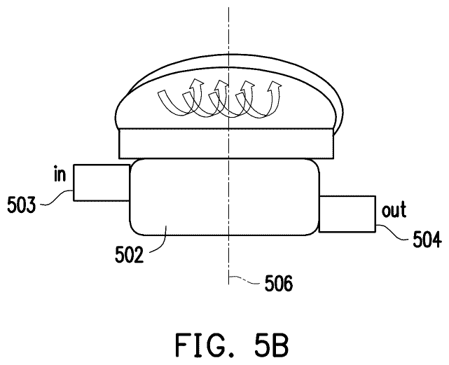

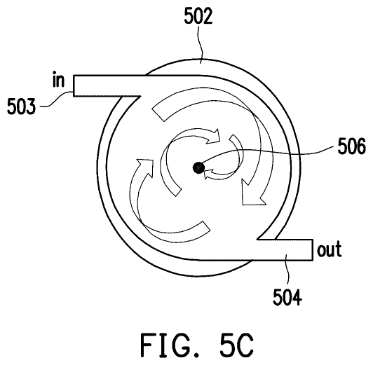

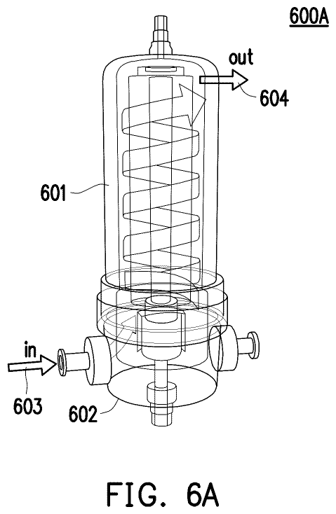

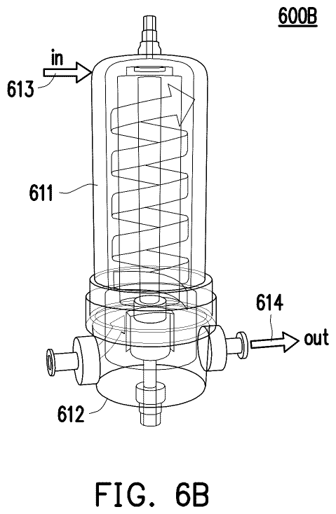

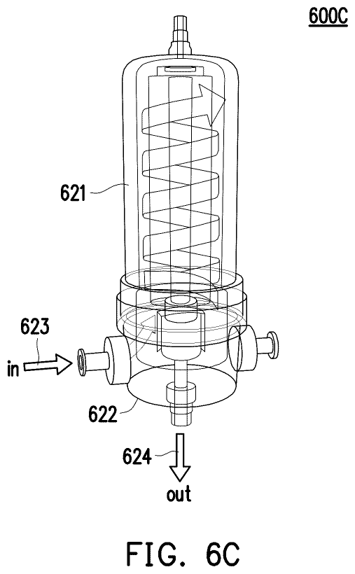

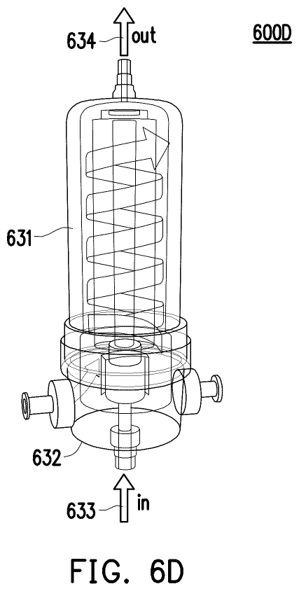

In some embodiments, the filter housings 403 in FIG. 4A and the filter housings 413 in FIG. 4B are described below in detail with respect to the filter housing 500 of FIG. 5A and the filter housings 600A of FIGS. 6A, 600B of FIGS. 6B, 600C of FIG. 6C, and 600D of FIG. 6D.

FIG. 5A illustrates a schematic view of a filter housing 500 in accordance with some embodiments of the present disclosure. FIG. 5B illustrates a side view of a base of the filter housing 500 in accordance with some embodiments of the present disclosure. FIG. 5C illustrates a top view of a base of the filter housing 500 in accordance with some embodiments of the present disclosure.

As shown in FIG. 5A, the filter housing 500 includes a cover 501 and a base 502. The cover 501 is attachable to the base 502 to provide a flow path 505 for the cleaning fluid to flow through the filter housing 500. A filter 510 may be positioned in the filter housing 500, such that when the cleaning fluid passes through the filter housing 500, the filter 510 is rinsed and/or cleaned by the cleaning fluid. Therefore, metal particles and/or other contaminant particles in the filter 510 are reduced and/or removed by the cleaning fluid.

In some embodiments, the cover 501 has a cylindrical shape. In some embodiments, the cover 501 has other shapes.

In some embodiments, as shown in FIG. 5A, the flow path 505 spirals around an axis 506 of the filter housing 500 along an inside wall of the cover 501.

In some embodiments, the filter housing 500 further includes an inlet 503 and an outlet 504 positioned at the base 502 of the filter housing 500. In some embodiments, as shown in FIGS. 5B and 5C, the inlet 503 and the outlet 504 are offset from the axis 506, such that the cleaning fluid spirals around the axis 506 of the filter housing 500 along the inside wall of the cover 501.

In some embodiments, the inlet and the outlet have arrangements as described below with respect to the filter housing 600A of FIG. 6A, the filter housing 600B of FIG. 6B, the filter housing 600C of FIG. 6C, and the filter housing 600D of FIG. 6D.

FIGS. 6A, 6B, 6C, and 6D illustrate schematic views of example filter housings in accordance with some embodiments of the present disclosure.

In some embodiments, as shown in FIG. 6A, a filter housing 600A includes an inlet 603 and an outlet 604. The inlet 603 is positioned at a base 602 of the filter housing 600A. The outlet 604 is positioned at a top of the cover 601 of the filter housing 600A.

In some embodiments, as shown in FIG. 6B, a filter housing 600B includes an inlet 613 and an outlet 614. The inlet 613 is positioned at a top of the cover 611 of the filter housing 600B. The outlet 614 is positioned at a base 612 of the filter housing 600B.

In some embodiments, as shown in FIG. 6C, a filter housing 600C includes an inlet 623 and an outlet 624. The inlet 623 is positioned at a base 622 of the filter housing 600C. The outlet 624 is positioned at a center of the base 622 of the filter housing 600C.

In some embodiments, as shown in FIG. 6D, a filter housing 600D includes an inlet 633 and an outlet 634. The inlet 633 is positioned at a center of a base 632 of the filter housing 600D. The outlet 634 is positioned at a center of a top of the cover 631 of the filter housing 600D.

FIGS. 7A and 7B illustrate a computer system 700 for implementing various methods described herein, in accordance with some embodiments of the present disclosure. In some embodiments, the computer system 700 is used for performing the functions of the controller 150 of FIG. 1, steps of method 200 of FIG. 2, and the functions of the AI engine 300 of FIG. 3.

FIG. 7A is a schematic view of a computer system that performs the functions of an apparatus for cleaning the filters. All of or a part of the processes, methods, and/or operations of the foregoing embodiments can be realized using computer hardware and computer programs executed thereon. In FIG. 7A, a computer system 700 is provided with a computer 701 including an optical disk read only memory (e.g., CD-ROM or DVD-ROM) drive 705 and a magnetic disk drive 706, a keyboard 702, a mouse 703, and a monitor 704.

FIG. 7B is a diagram showing an internal configuration of the computer system 700. In FIG. 7B, the computer 701 is provided with, in addition to the optical disk drive 705 and the magnetic disk drive 706, one or more processors, such as a micro processing unit (MPU) 711, a read only memory (ROM) 712 in which a program such as a boot up program is stored, a random access memory (RAM) 713 that is connected to the MPU 711 and in which a command of an application program is temporarily stored and a temporary storage area is provided, a hard disk 714 in which an application program, a system program, and data are stored, and a bus 715 that connects the MPU 711, the ROM 712, and the like. Note that the computer 701 may include a network card (not shown) for providing a connection to a LAN.

The program for causing the computer system 700 to execute the functions for cleaning filters in the foregoing embodiments may be stored in an optical disk 721 or a magnetic disk 722, which are inserted into the optical disk drive 705 or the magnetic disk drive 706, and transmitted to the hard disk 714. Alternatively, the program may be transmitted via a network (not shown) to the computer 701 and stored in the hard disk 714. At the time of execution, the program is loaded into the RAM 713. The program may be loaded from the optical disk 721 or the magnetic disk 722, or directly from a network. The program does not necessarily have to include, for example, an operating system (OS) or a third-party program to cause the computer 701 to execute the functions of the control system for removing contaminant particles on the patterning mask of the lithography system in the foregoing embodiments. The program may only include a command portion to call an appropriate function (module) in a controlled mode and obtain desired results.

The novel apparatuses and the methods according to the present disclosure provide an improved apparatus and methods for cleaning the filters, thereby reducing metal particles or other contaminant particles in the filters. Embodiments of the disclosure provide apparatuses and methods using artificial intelligence (AI) to assist with determining conditions of the filters and selecting flowing parameters of the cleaning fluid to reduce and/or remove the metal particles or other contaminant particles in the filters. Consequently, efficiency for determining conditions of the filters and selecting flowing parameters of the cleaning fluid can be improved.

According to some embodiments of the present disclosure, a method for cleaning a filter includes flowing a cleaning fluid through a filter housing to clean the filter in the filter housing and obtaining flowing parameters of the cleaning fluid. The method further includes determining a condition of the filter based on the flowing parameters of the cleaning fluid, and associating the flowing parameters to attributes of the filter when the condition of the filter is clean. In an embodiment, the method further includes training an artificial intelligence engine with the flowing parameters of the cleaning fluid. In an embodiment, the method further includes adjusting the flowing parameters based on the condition of the filter. In an embodiment, the filter housing includes an inlet and an outlet, and the cleaning fluid flows into the filter housing through the inlet and out of the filter housing through the outlet, and the inlet is positioned on a base of the filter housing, wherein the inlet is configured to be offset from a center of the base, such that the cleaning fluid flows spirally along a wall of the filter housing. In an embodiment, the outlet is positioned on the base of the filter housing or a top of the filter housing. In an embodiment, the flowing parameters include at least one of a concentration of metal particles in the cleaning fluid, a flow rate of the cleaning fluid, a pressure drop of the cleaning fluid, a particle count of the cleaning fluid, and a flush volume of the cleaning fluid. In an embodiment, a sensor is configured to obtain the flowing parameters of the cleaning fluid in real-time. In an embodiment, a controller is electrically coupled to the sensor and configured to obtain the flowing parameters of the cleaning fluid and determine the condition of the filter based on the flowing parameters of the cleaning fluid. In an embodiment, flowing the cleaning fluid through the filter housing includes pumping the cleaning fluid from a tank to the filter housing and circulating the cleaning fluid from the filter housing to the tank.

According to some embodiments of the present disclosure, a method for flowing a cleaning fluid through a filter housing to clean the filter in the filter housing, and providing attributes of the filter to an artificial intelligence engine. The method further includes determining, by the artificial intelligence engine, flowing parameters of the cleaning fluid based on the attributes of the filter, and associating the flowing parameters to the filter when a condition of the filter is clean.

According to some embodiments of the present disclosure, an apparatus for cleaning a filter includes a processor; and a non-transitory computer readable storage medium storing a program. The processor is programmed to flow a cleaning fluid through a filter housing to clean the filter in the filter housing, and obtain flowing parameters of the cleaning fluid. The program is further programmed to determine a condition of the filter based on the flowing parameters of the cleaning fluid, and associate the flowing parameters to attributes of the filter when the condition of the filter is clean.

The foregoing outlines features of several embodiments or examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments or examples introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method for cleaning a filter, comprising:
flowing a cleaning fluid through a filter housing to clean the filter in the filter housing;
obtaining flowing parameters of the cleaning fluid;
determining a condition of the filter based on the flowing parameters of the cleaning fluid; and
associating the flowing parameters to attributes of the filter when the condition of the filter is clean.

2. The method of claim 1, further comprising:
training an artificial intelligence engine with the flowing parameters of the cleaning fluid.

3. The method of claim 1, further comprising:
adjusting the flowing parameters based on the condition of the filter.

4. The method of claim 1, wherein:
the filter housing includes an inlet and an outlet, and the cleaning fluid flows into the filter housing through the inlet and out of the filter housing through the outlet, and
the inlet is positioned on a base of the filter housing, wherein the inlet is configured to be offset from a center of the base, such that the cleaning fluid flows spirally along a wall of the filter housing.

5. The method of claim 4, wherein the outlet is positioned on the base of the filter housing or a top of the filter housing.

6. The method of claim 1, wherein the flowing parameters include at least one of a concentration of metal particles in the cleaning fluid, a flow rate of the cleaning fluid, a pressure drop of the cleaning fluid, a particle count of the cleaning fluid, and a flush volume of the cleaning fluid.

7. The method of claim 1, wherein a sensor is configured to obtain the flowing parameters of the cleaning fluid in real-time.

8. The method of claim 7, wherein a controller is electrically coupled to the sensor and configured to obtain the flowing parameters of the cleaning fluid and determine the condition of the filter based on the flowing parameters of the cleaning fluid.

9. The method of claim 1, wherein flowing the cleaning fluid through the filter housing includes:
pumping the cleaning fluid from a tank to the filter housing; and
circulating the cleaning fluid from the filter housing to the tank.

10. A method for cleaning a filter, comprising:
flowing a cleaning fluid through a filter housing to clean the filter in the filter housing;
providing attributes of the filter to an artificial intelligence engine;
determining, by the artificial intelligence engine, flowing parameters of the cleaning fluid based on the attributes of the filter; and
associating the flowing parameters to the filter when a condition of the filter is clean.

11. The method of claim 10, further comprising:
adjusting the flowing parameters based on the condition of the filter.

12. The method of claim 10, wherein:
the filter housing includes an inlet and an outlet, and the cleaning fluid flows into the filter housing through the inlet and out of the filter housing through the outlet, and
the inlet is positioned on a base of the filter housing, wherein the inlet is configured to be offset from a center of the base, such that the cleaning fluid flows spirally along a wall of the filter housing.

13. The method of claim 12, wherein the outlet is positioned on the base of the filter housing or a top of the filter housing.

14. The method of claim 10, wherein the flowing parameters include at least one of a concentration of metal particles in the cleaning fluid, a flow rate of the cleaning fluid, a pressure drop of the cleaning fluid, a particle count of the cleaning fluid, and a flush volume of the cleaning fluid.

15. The method of claim 10, wherein a sensor is configured to obtain the flowing parameters of the cleaning fluid in real-time.

16. The method of claim 15, wherein a controller is electrically coupled to the sensor and configured to obtain the flowing parameters of the cleaning fluid and determine the condition of the filter based on the flowing parameters of the cleaning fluid.

17. The method of claim 10, wherein flowing the cleaning fluid through the filter housing. includes:
pumping the cleaning fluid from a tank to the filter housing; and
circulating the cleaning fluid from the filter housing to the tank.

18. An apparatus for cleaning a filter, comprising:
a processor; and
a non-transitory computer readable storage medium storing a program, wherein the processor is programmed to:
flow a cleaning fluid through a filter housing to clean the filter in the filter housing;
obtain flowing parameters of the cleaning fluid;
determine a condition of the filter based on the flowing parameters of the cleaning fluid; and
associate the flowing parameters to attributes of the filter when the condition of the filter is clean.

19. The apparatus of claim 18, wherein the processor is further programmed to train an artificial intelligence engine with the flowing parameters of the cleaning fluid.

20. The apparatus of claim 18, wherein the filter housing includes an inlet and an outlet, and the cleaning fluid flows into the filter housing through the inlet and out of the filter housing through the outlet.
